(19) United States
(12) Patent Application Publication
(10) Pub. No.: US 2022/0231550 A1
(43) Pub. Date: Jul. 21, 2022

(54) MOTOR FOR VEHICLE

(71) Applicant: TOYOTA JIDOSHA KABUSHIKI KAISHA, Toyota-shi Aichi-ken (JP)

(72) Inventors: Ryota Morimoto, Toyota-shi Aichi-ken (JP); Kenichi Ichinose, Toyota-shi Aichi-ken (JP); Hiroshi Yoshimoto, Toyota-shi Aichi-ken (JP); Toshio Watari, Toyota-shi Aichi-ken (JP)

(73) Assignee: TOYOTA JIDOSHA KABUSHIKI KAISHA, Toyota-shi Aichi-ken (JP)

(21) Appl. No.: 17/522,359

(22) Filed: Nov. 9, 2021

(30) Foreign Application Priority Data
Jan. 19, 2021 (JP) 2021-006716

(51) Int. Cl. H02K 1/16; H02K 1/27; B60L 50/51

(52) U.S. Cl. CPC H02K 1/16; H02K 2213/03; B60L 50/51; H02K 1/27

(57) ABSTRACT

In a motor for a vehicle, a protrusion portion is formed to protrude from a stator body of a stator. Therefore, an amount of a magnetic field emitted to a side of an occupant of a vehicle is suppressed. In addition, a reduction value of the magnetic field emitted to the side of the occupant of the vehicle is decided based on an amount of protrusion of the protrusion portion and a length of the protrusion portion in a circumferential direction of a rotation of a rotor.

### CROSS-REFERENCE TO RELATED APPLICATION

This application claims priority to Japanese Patent Application No. 2021-006716 filed on Jan. 19, 2021, incorporated herein by reference in its entirety.

### BACKGROUND

### 1. Technical Field

The present disclosure relates to a motor for a vehicle mounted on a vehicle.

### 2. Description of Related Art

For example, Japanese Unexamined Patent Application Publication No. 2017-212239 (JP 2017-212239 A) discloses an electromagnetic shield material that blocks electromagnetic waves. JP 2017-212239 A aims to reduce weight of the electromagnetic shield material. However, even when the weight of the electromagnetic shield material is reduced, for example, the electromagnetic shield material is provided in a motor, so that weight of the motor is increased by an amount of the electromagnetic shield material.

### SUMMARY

The present disclosure is to obtain a motor for a vehicle capable of suppressing a magnetic field received by an occupant of a vehicle and suppressing an increase in weight.

A first aspect of the present disclosure relates to a motor for a vehicle including a stator, a rotor, and a protrusion portion. The stator is configured to form a magnetic field around the stator. The rotor is configured to rotate by an interaction with the magnetic field formed by the stator. The protrusion portion is formed to protrude from a part of an outer periphery of a stator body of the stator to a side of an occupant of a vehicle, of which a parameter is set based on at least one of a protrusion dimension from the stator body and a dimension along a circumferential direction of a rotation of the rotor.

In the motor according to the first aspect of the present disclosure, when the magnetic field is formed around the stator by the stator, the rotor rotates by the interaction with the magnetic field formed by the stator. In addition, the protrusion portion is formed to protrude from the part of the outer periphery of the stator body of the stator to the side of the occupant of the vehicle. The parameter of the protrusion portion is set based on at least one of the protrusion dimension from the stator body and the dimension along the circumferential direction of the rotation of the rotor.

Therefore, the increase in the weight of the motor for a vehicle can be suppressed, and the magnetic field in a specific direction to the side of the occupant can be suppressed. As described above, in the present disclosure, the magnetic field received by the occupant can be reduced without using a protective shield, such as a metal plate, so that a cost can be reduced while the increase in the weight is suppressed.

A second aspect of the present disclosure relates to the motor according to first aspect, in which the protrusion portion protrudes in an arc shape coaxial with the stator body.

In the motor according to the second aspect, an outer peripheral portion of the protrusion portion has an arc shape coaxial with the stator body, a length from a rotation center to an outer peripheral end portion of the protrusion portion is fixed. As a result, an amount of reduction in the magnetic field can be set to be fixed in the circumferential direction.

A third aspect of the present disclosure relates to the motor according to first or second aspect, in which a ratio of a length of the protrusion portion in the circumferential direction to a length of the stator body in the circumferential direction is smaller than a predetermined value.

By reducing the ratio of the length of the protrusion portion in the circumferential direction, the weight of the motor for a vehicle can be effectively reduced while an influence of the magnetic field on the occupant is reduced.

As described above, in the motor for a vehicle according to the aspects of the present disclosure, the magnetic field received by the occupant of the vehicle can be suppressed and the weight of the motor for a vehicle can be reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view of a motor for a vehicle according to an embodiment of the present disclosure as viewed from a vehicle width direction side; and

FIG. 2 is a graph showing a relationship between a parameter and an amount of reduction in a magnetic field (dB).

### DETAILED DESCRIPTION OF EMBODIMENTS

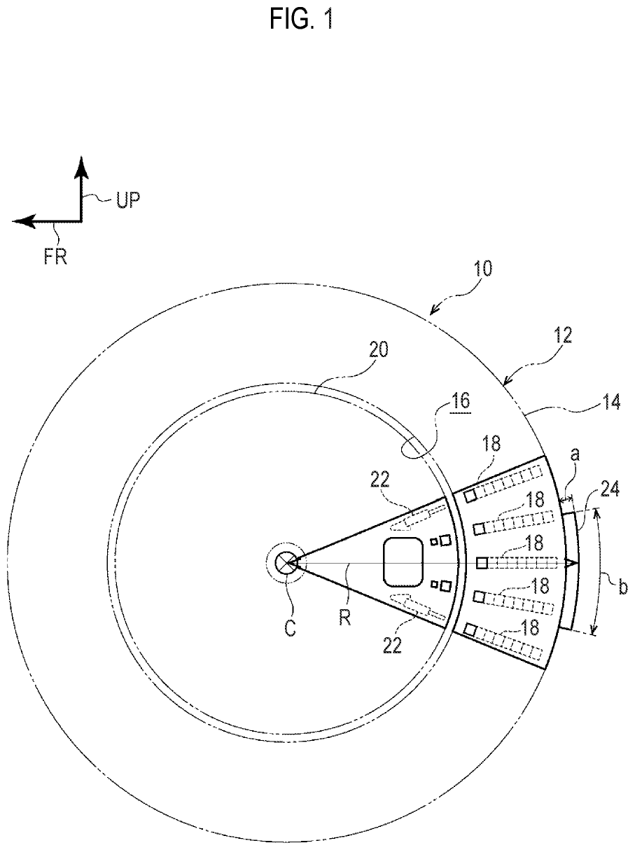

Hereinafter, a vehicle substructure according to an embodiment of the present disclosure will be described with reference to FIG. 1. Note that an arrow FR appropriately shown in FIG. 1 indicates a front side (vehicle front side) of a vehicle to which a motor 10 for a vehicle is applied. In addition, an arrow UP indicates an upper side of the vehicle.

As shown in FIG. 1, the motor 10 for the vehicle includes a stator 12, and the stator 12 includes a stator body 14. In FIG. 1, for convenience of description, solely one stator 12 divided into eight equal parts in a circumferential direction is drawn by a solid line. The stator body 14 includes a hollow portion 16. The hollow portion 16 has a circular cross-sectional shape orthogonal to a vehicle width direction (a depth side of a paper surface and a front side of the paper surface in FIG. 1). In addition, the stator body 14 is provided with a plurality of coils 18. By energizing the coils 18, a magnetic field (rotation magnetic field) is formed around the stator 12.

In addition, a rotor 20 is included inside the hollow portion 16 of the stator body 14. The rotor 20 includes a plurality of permanent magnets 22. The permanent magnets 22 form a magnetic field around the rotor 20. The rotor 20 rotates around an axis with the vehicle width direction as an axial direction by an interaction between the magnetic field (rotation magnetic field) formed around the stator 12 by energizing the coils 18 of the stator body 14 and the magnetic field formed around the rotor 20 by the permanent magnets 22 of the rotor 20.

In addition, a protrusion portion 24 is formed from an outer peripheral portion of the stator body 14 of the stator 12 on a side of an occupant of the vehicle. In a case where an outer peripheral shape of the stator body 14 is regarded as a circle, the protrusion portion 24 protrudes in an arc shape coaxial with the outer peripheral portion of the stator body 14.

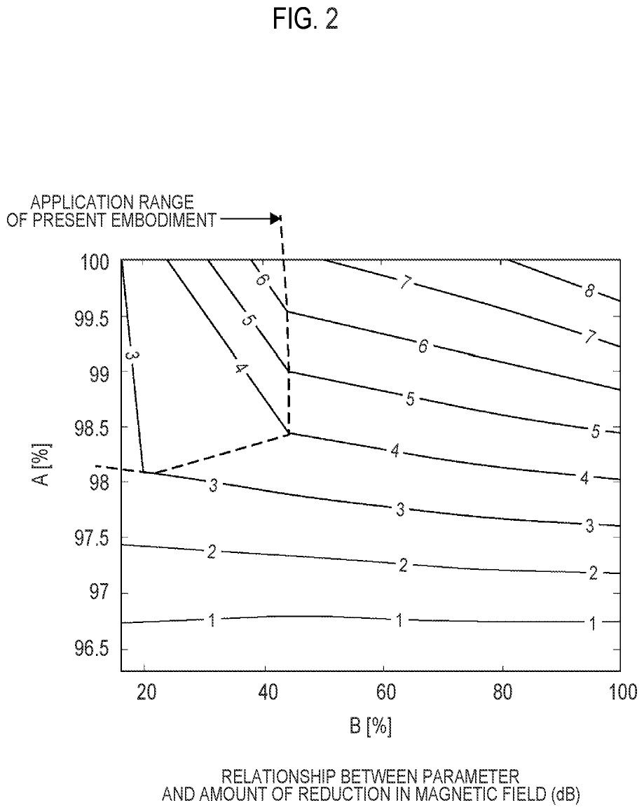

Here, in a graph of FIG. 2, an amount of reduction in the magnetic field in a case where the magnetic field is observed from the side of the occupant of the vehicle with respect to the protrusion portion 24 is shown by a decibel (dB). For example, in a line described as 4 in FIG. 2, the amount of reduction in the magnetic field of 4 dB can be obtained. In addition, a vertical axis A of FIG. 2 is a value (%) obtained by the following expression (1).

A=(R−a)·100/R (1)

Here, R is a distance from a rotation center C of the rotor 20 to an outer peripheral end portion of the protrusion portion 24. In addition, a is an amount of protrusion of the protrusion portion 24 from the outer peripheral portion of the stator body 14 of the stator 12.

On the other hand, a horizontal axis B in FIG. 2 is a value (%) obtained by the following expression (2).

B=·100/(2πR·1/8) (2)

Here, since b is a length of the protrusion portion 24 in the circumferential direction of the rotation of the rotor 20, B is a ratio of a length of b in the circumferential direction with respect to an arc length obtained by dividing the length of the stator body 14 in the circumferential direction by one-eighth.

As can be seen from FIG. 2, by reducing a ratio of B, the length of the protrusion portion 24 in the circumferential direction of the rotation of the rotor 20 is reduced. Therefore, an amount of reduction in weight of the stator 12 is larger than that in a case where a ratio of A is reduced. As an example, a dimension of the protrusion portion 24 shown in FIG. 1 is set to about 98.5% for A and about 45% for B.

Here, when A and B are set to be within a range surrounded by a chain line in FIG. 2, weight of the motor 10 for the vehicle can be effectively reduced while an influence of the magnetic field is reduced. That is, in the range, since an interval between the amount of reduction in the magnetic fields 3 and 4 is wide, the amount of reduction in the magnetic field is not significantly changed even in a case where the ratio of B is reduced. Therefore, the weight of the motor 10 for the vehicle can be effectively reduced while the influence of the magnetic field on the occupant is reduced.

Therefore, by reducing the ratio of B as much as possible and defining, based on FIG. 2, a structure of the protrusion portion 24, such as the amount of protrusion of the protrusion portion 24 from the outer peripheral portion of the stator body 14 within a range in which the magnetic field can be efficiently reduced, the weight of the motor 10 for the vehicle can be reduced, and the magnetic field emitted by the motor 10 for the vehicle to the outside on the side of the occupant of the vehicle can be effectively reduced.

In addition, as shown in FIG. 1, by forming the protrusion portion 24 into the arc shape coaxial with the outer peripheral portion of the stator body 14, the length from the rotation center C to the outer peripheral end portion of the protrusion portion 24 is fixed. As a result, the amount of reduction in the magnetic field can be set to be fixed in the circumferential direction.

Note that in the present embodiment, both A and B are used, but solely any one of A and B may be used, any one of A and B and at least the other one of A and B may be used, or at least one other than A and B may be used.

What is claimed is:

1. A motor for a vehicle comprising:
a stator configured to form a magnetic field around the stator;
a rotor configured to rotate by an interaction with the magnetic field formed by the stator; and
a protrusion portion formed to protrude from a part of an outer periphery of a stator body of the stator to a side of an occupant of a vehicle, of which a parameter is set based on at least one of a protrusion dimension from the stator body and a dimension along a circumferential direction of a rotation of the rotor.

2. The motor according to claim 1, wherein the protrusion portion protrudes in an arc shape coaxial with the stator body.

3. The motor according to claim 1, wherein a ratio of a length of the protrusion portion in the circumferential direction to a length of the stator body in the circumferential direction is smaller than a predetermined value.
